(19) United States
(12) Patent Application Publication
(10) Pub. No.: US 2002/0125412 A1
(43) Pub. Date: Sep. 12, 2002

(54) Optical resolver and method of use

(76) Inventor: Donald E. Barnett, West Chester, PA (US)

Correspondence Address: Douglas Wm. Massinger, Esquire, MASSINGER LAW OFFICE, 113 N. Olive Street, Media, PA, 19063, US

(21) Appl. No.: 10/095,542

(22) Filed: Mar. 11, 2002

Related U.S. Application Data
(60) Provisional application No. 60/274,672, filed on Mar. 9, 2001.

(51) Int. Cl. G02F 1/01

(52) U.S. Cl. 250/225

(57) ABSTRACT

A rotary motion detection device for measuring the angle of rotation of a rotating shaft is comprised of an illumination source, an optical linear polarizer in the shape of a disk with central aperture there through for the slidable reception of a rotating shaft member, at least one stationary linear polarizer and at least one photodetector. The device is capable of providing absolute position information, infinite resolution of analog signals, ease of installation and environmental tolerance. The subject invention is further of small and light construction, employs a simple electrical interface, direct current supply voltage and offers vastly improved mechanical tolerances over the prior art. Additionally, concentricity of the rotating member, width of the non-contacting gap, axial endplay, runout and perpendicularity of the driving shaft are all inconsequential.

### CROSS REFERENCE TO RELATED APPLICATION

This application claims the benefit of U.S. Provisional Patent Application No. 60/274,672 filed on Mar. 9, 2001.

### FIELD OF THE INVENTION

The subject invention relates to rotary motion control systems in general, and to a novel optical electronic device capable of measuring an angle of rotation of a rotating to member for purposes of determining the speed, displacement and direction thereof, in particular.

### BACKGROUND OF THE INVENTION

Present rotary motion control systems employ either optical or non-optical devices to sense the speed, direction and position of a rotating shaft. Such devices function as transducers by transforming mechanical motion into electronic information. This information is then fed to electronic devices which control the mechanical motion of the target apparatus. Feedback is the vital link that closes the control system loop to improve motion performance.

Known optical devices rely on optoelectronic components to detect rotary motion. More specifically, optical encoders measure the angle of rotation of a rotating member and are comprised of a light source, a “codewheel” secured to the rotating member, and a stationary photodetector. The light source emits a beam across a gap onto the photodetector. The codewheel, which is a disc with graduated patterns of optically transmissive and opaque areas, rotates between the source and detector. The pattern is usually a large number of evenly spaced lines at the optical radius around the axis of rotation. The optically transmissive or clear areas allow light to pass through the codewheel whereas the opaque areas interrupt the light beam, allowing little or no light to reach the photodetector. Light that does reach the photodetector produces an electrical current proportional to the intensity of the illumination reaching it. It may be appreciated then that the codewheel pattern is so arranged as to produce differing levels of photocurrent in a photo detector at given angles of rotation of the codewheel (and shaft). The output of the photodetector is a DC level rising and falling as the lines on the codewheel pass through the light path. Each change in state between high and low levels represents an incremental angle of rotation of the codewheel.

Non-optical devices for measuring angle of rotation are comprised of a rotating magnetic field and a sensor for detecting the variation in magnetic flux as the magnetic field is rotated. Such devices are known by various names that depend on how the magnetic field is generated and the technology used to detect the variation in flux of the rotating magnetic field. The magnetic device that most closely resembles the invention herein is known as a resolver (hereafter referred to as a “magnetic resolver”). A basic magnetic resolver consists of a rotating coil of wire (a “rotor”) concentrically oriented with a stationary coil of wire (a “stator”) and an open area or gap in between. An electrical current is applied to the rotor inducing a voltage across the gap in the stator. The electrical current generated in the stator is measured. The ratio of the two currents is a function of the angle between the rotating and stationary coils. The output of a resolver is an analog AC voltage equivalent to the absolute angle between the rotor and stator.

The above described optical encoders and magnetic resolvers of the prior art do suffer from various shortcomings and limitations. Several of these problems are briefly discussed below. A brief discussion of how the subject invention substantially obviates these problems may be found in the Summary of the Invention.

First, the accuracy of an optical encoder or a resolver is directly affected by the concentricity of the rotating member around the axis of rotation. In the optical encoder, the encoded pattern on the disk must be concentric and in the resolver, the magnetic field must be concentric. Deviation from concentricity result in loss of accuracy.

Secondly, the non-contacting gap of optical encoders and magnetic resolvers is critical to their accuracy, reliability, and robustness. If the non-contacting gap is too small in either device, the gap may close under environmental stresses causing catastrophic failure. And if the gap is too large, the signals produced by the device may be subject to intermittent failures due to environmental changes or sources of electrical noise. The ideal non-contacting gap approaches zero. A smaller gap produces a better electrical signal. However, a large gap allows for greater environmental and mechanical tolerances. Therefore an optimum gap must be established for a given device in a given application.

Additionally, because the non-contacting gap in optical encoders and magnetic resolvers is small, it is important for the rotating member to be parallel with the stationary member. If the rotating and stationary members come into contact, the device can be destroyed. Even if a gap is maintained, a variation in the gap as the axis rotates contributes to angular position errors and in the extreme, intermittent failure.

Another limitation of encoders is their subjectivity to contamination. Encoders use small portions of the codewheel to detect angles of rotation. Small bits of contamination can have a great effect on the optical path and thus on the accuracy of the device.

Further, some angle measurement applications require the measuring device to be positioned at a particular angle relative to its axis. For instance, zero degrees relative to a flat on a shaft. For optical encoders and magnetic resolvers, this requires rotating the stationary member about its axis. This can be a difficult process often resulting in damage to the device or the introduction of measurement errors.

The typical magnetic resolver or optical encoder has two primary signals. These signals are roughly a sine and a cosine at an ideal phase of 90 electrical degrees from each other. Errors in the phase relationship between the two signals will translate to position errors affecting the accuracy of the device. The phase in these devices is a function of the physical relationship of the sensing elements, which is substantially fixed and cannot be adjusted.

Optical encoders, both reflective and transmissive, are intended to provide a two level binary output. The optical density of the encoded pattern is not capable of providing precise sinusoidal variation of illumination. Sine/Cosine incremental optical encoders are available but the output signal is only approximately sinusoidal.

Resolvers typically require about one watt of electrical power during operation. An optical encoder will need ½ to 3 watts depending on the number of signals and termination of the output. It would be desirable to have a device requiring less power.

Optical encoders are capable of providing direct digital output. However, the incremental nature of the digital encoder does not provide absolute position information on system initialization. Applications requiring immediate absolute feedback have had to implement expensive absolute optical encoders.

Magnetic resolvers are made of copper wire coils wound around iron laminations. Though these materials are very tough they are heavy and have high inertia which causes problems in some applications. Optical encoders have optical gratings that must be precisely placed. These gratings are difficult to fabricate and are fragile.

Clearly there exists a need for a rotary motion transducer device which overcomes the above described shortcomings and limitations of the prior art while taking advantage the many positive aspects associated with both optical encoders and magnetic resolvers.

### SUMMARY OF THE INVENTION

The present invention substantially resolves each of the above described shortcomings and limitations of the prior art by providing a rotary motion transducer capable of providing absolute position information, infinite resolution of analog signals, ease of installation and environmental tolerance. The subject invention is further of small and light construction, employs a simple electrical interface, direct current supply voltage and offers vastly improved mechanical tolerances over the prior art. Additionally, concentricity of the rotating member, width of the non-contacting gap, axial endplay, runout and perpendicularity of the driving shaft are all inconsequential.

With regard to construction, all embodiments of the subject optical resolver share in common four necessary components: an illumination source, an optical linear polarizer in the shape of a disk with central aperture there through for the slidable reception of a rotating shaft member, a stationary linear polarizer and a photodetector. A low cost assembly for motion control feedback would use an LED for illumination, polarizing filters for both the disk and stationary reference, and a phototransistor for a detector.

Although the basic optical resolver requires only one electrical signal for position information, two signals offer better accuracy and provide direction information. Accordingly, in a second embodiment, a second polarization filter and photodetector are added to the optical path so that a second electrical signal can be generated. The polarization of the second polarizer is orientated at 45 degrees relative to the first polarizer. The two corresponding photodetectors generate a sine and a cosine signal at 90 degrees electrical phase. As with a magnetic resolver, the absolute angle of the rotating polarizer can be calculated as the arctangent of the ratio of the sine and cosine values. The direction of rotation is given by simply determining which is the leading signal. The frequency of the signals gives us the velocity of rotation.

The present invention accordingly provides a novel rotary motion transducer employing optically polarized materials in the rotating member and the stationary detecting member. Unlike optical encoders, no encoded pattern is required nor used to produce a change in the photocurrent of the photo detector as the rotating member rotates. The change in photocurrent is a function of the change in opacity of the two polarized members as one member rotates with respect to the other.

The optical principal employed is known as Malus's Law. If natural light having random polarization is incident on an ideal linear polarizer, only light in a P-state will be transmitted. That P-state will have an orientation parallel to a specific direction along the transmission axis of the polarizer. If the polarizer is rotated about its perpendicular z-axis, the total intensity of transmitted light is unchanged because of the complete symmetry of unpolarized light. Further, if a second identical ideal polarizer is introduced along the z-axis of the first polarizer, only its component of light parallel to the transmission axis of the first polarizer will be transmitted. The maximum transmission occurs when the angel between the transmission axis of the first and second polarizer is zero. The equation for the irradiance transmitted by the system is

I(θ)=I(0) cos² θ.

According to the above equation, I(90°) equals zero when the transmission axis of the two polarizers are perpendicular. This occurs because the second polarizer filters all of the polarized light passing through the first polarizer. The square of the cosine in the equation accounts for the fact that the maximum and minimum transmission of the system occurs twice per 360° rotation of the angel between transmission axes of the two polarizers.

There has thus been outlined, rather broadly, the more important features of the invention in order that the detailed description thereof that follows may be better understood, and in order that the present contribution to the art may be better appreciated. There are, of course, additional features of the invention that will be described hereinafter and which will form the subject matter of the claims appended hereto. In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting. As such, those skilled in the art will apprecieate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

Further, the purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

It is, therefore, a primary object of the subject invention to provide a novel rotary motion transducer capable of measuring an absolute angle of rotation of a rotating member, together with its velocity and direction of rotation.

Another primary object of the subject optical resolver is to transform mechanical rotary motion of a target apparatus into electronic information which may then be fed to electronic devices which control the mechanical motion of the target apparatus.

It is also an object of the present invention to provide a rotary motion transducer wherein concentricity of its components with the axis of rotation of the shaft of the target apparatus is not required.

It is another object of the present invention to provide a rotary motion transducer wherein gap size between the light source and polarization filter is not critical.

Still another object of the present invention is to provide a rotary motion transducer having a high tolerance to contamination.

Yet another object of the present invention is to provide a rotary motion transducer wherein the phase relationship of multiple signals can be adjusted relative to each other.

Another object of the present invention is to provide a rotary motion transducer capable of producing an infinitely resolvable analog signal.

A further object of the present invention is to provide a rotary motion transducer having low power requirements.

It is yet another object of the present invention to provide a rotary motion transducer which is simple in its construction, requires relatively few components, and is relatively inexpensive to build and maintain.

These together with other objects of the invention, along with the various features of novelty which characterize the invention, are pointed out with particularity in the claims annexed to and forming a part of this disclosure. For a better understanding of the invention, its advantages and the specific objects attained by its uses, reference should be had to the accompanying drawings and descriptive matter in which there is illustrated preferred embodiments of the invention.

### BRIEF DESCRIPTION OF THE DRAWINGS

The invention will be better understood and objects other than those set forth above will become apparent when consideration is given to the following detailed description thereof. Such description makes reference to the annexed drawings wherein:

FIG. 1 is an elevational view of the subject optical resolver;

FIG. 2 is an exploded view of the primary components of a first embodiment of the subject invention;

FIG. 3 is an exploded view of the primary components of a second embodiment of the subject invention;

FIG. 4 is a cross sectional view of the present invention illustrating the primary elements of the optical path;

FIG. 5 is a schematic diagram of the electrical system of the subject invention;

FIG. 6 is a chart of basic output electrical signals and absolute position equation for the subject invention; and

FIG. 7 is a table of primary, secondary and substitute components of the subject invention.

### DETAILED DESCRIPTION OF THE INVENTION

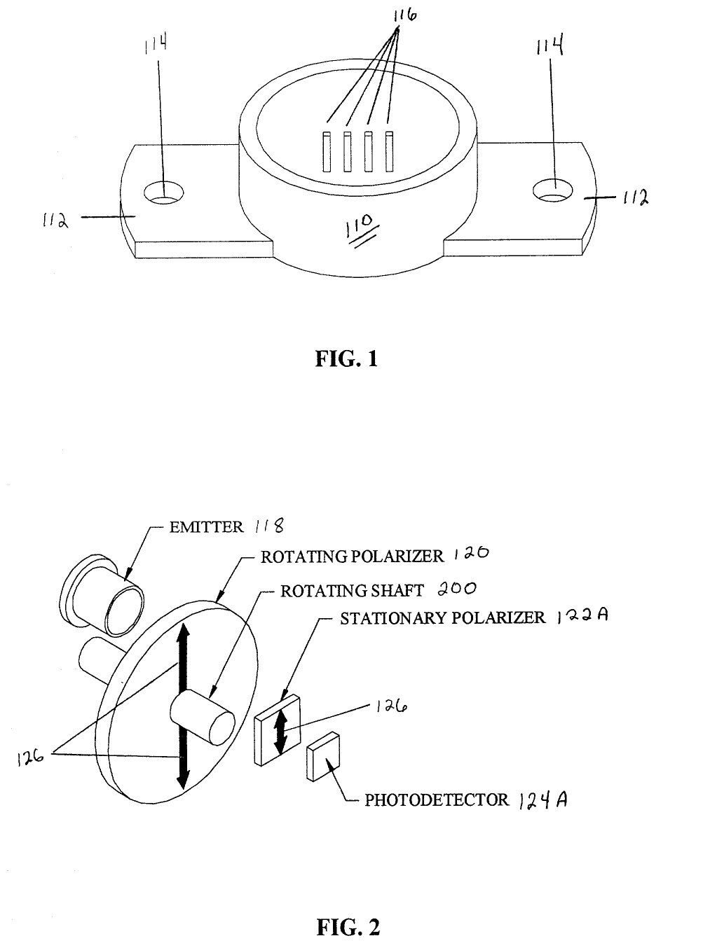

Reference is now made to FIG. 1 in which there is illustrated a pictorial view of the subject optical resolver of the present invention designated generally by reference numeral 100. FIG. 1 depicts the subject invention as completely assembled in housing 110. A pair of flanges 112 on each side of the unit have bolt holes 114 for attaching the unit to a surface. Four pins 116 protruding from the top are the electrical connections between the unit and cabling to the system electronics.

Referring now to FIG. 2, the primary components of the subject optical resolver may be observed in exploded view. There are four basic components in this simplest embodiment of the invention. An illumination source or light emitter 118, a disk-shaped optical linear polarizer 120 to be mounted directly or indirectly onto a rotating shaft 200 of a target apparatus, a stationary linear polarizer 122A and a photodetector 124A are the required elements. Note that arrows 126 indicate the direction of polarization. A low cost assembly for motion control feedback would use an LED as the illumination source, polarizing filters for the disk and stationary reference, and a phototransistor for the detector.

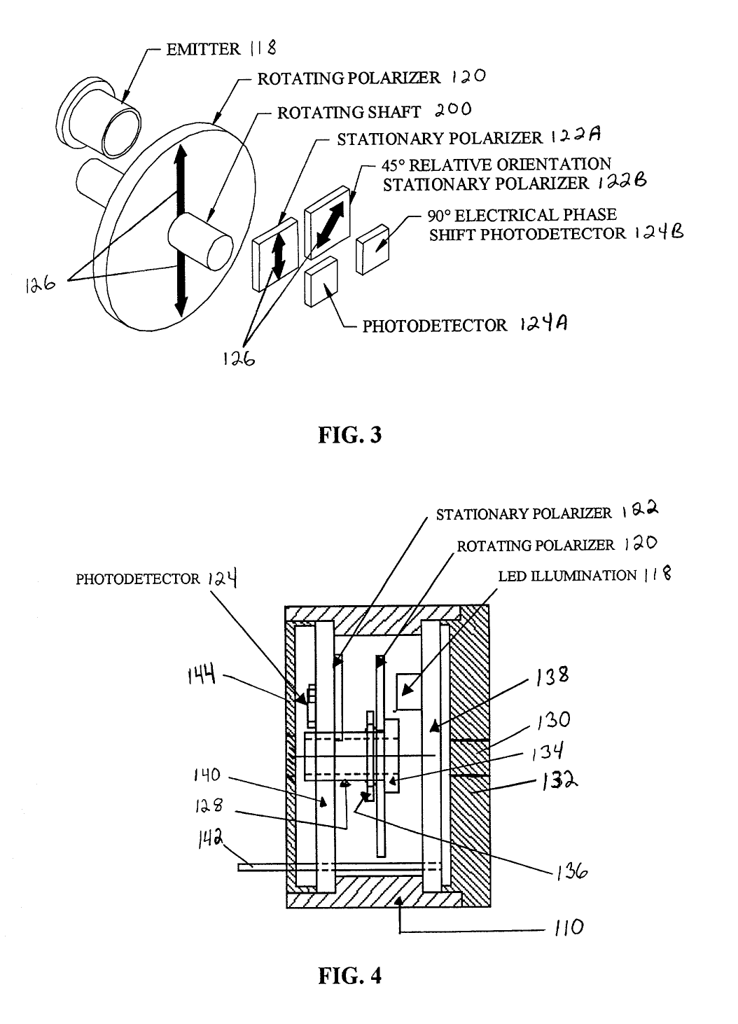

Although the basic optical resolver requires only one electrical signal for position information, two signals offer better accuracy and provide direction information. Referring to FIG. 3, a second polarization filter 122B and photodetector 124B are added to the optical path so that a second electrical signal can be generated. The polarization of the second polarizer 122B is orientated at 45 degrees relative to the first polarizer 122A. The two corresponding photodetectors 124A and 124B generate a sine and a cosine signal at 90 degrees electrical phase. As with a magnetic resolver, the absolute angle of the rotating polarizer can be calculated as the arctangent of the ratio of the sine and cosine values. The direction of rotation is given by simply determining which is the leading signal. The frequency of the signals provides the velocity of rotation.

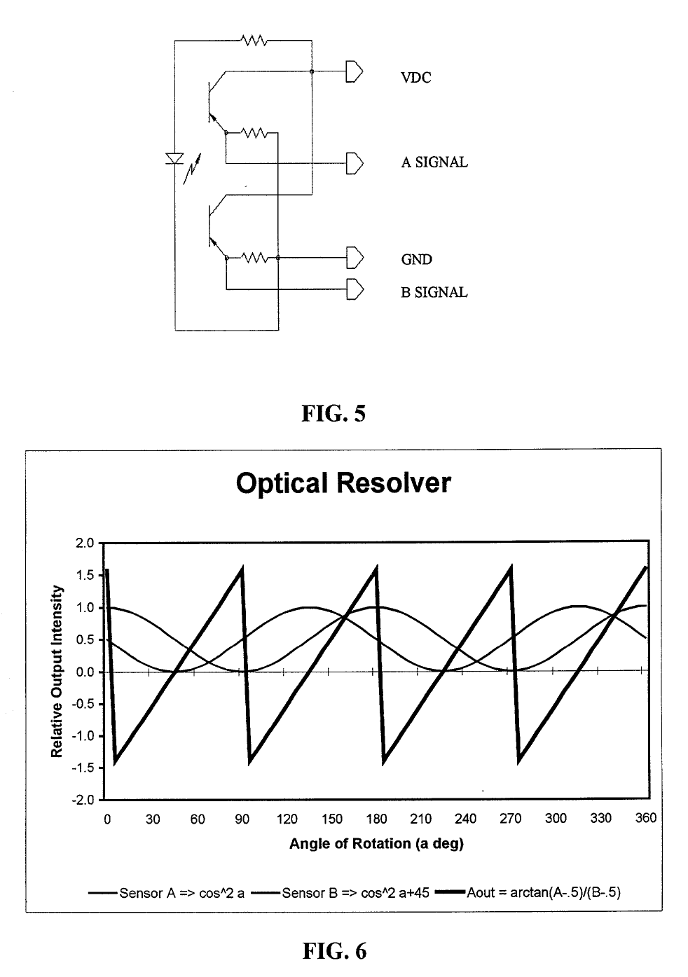

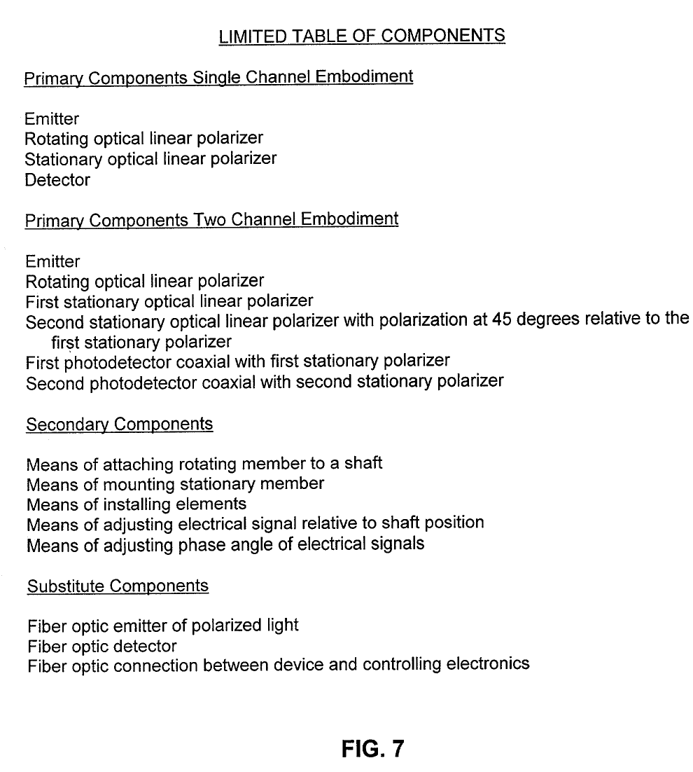

Reference is now invited to FIG. 5 wherein a schematic diagram of the electrical system of the subject invention is illustrated. The minimum two-signal embodiment of the subject invention only requires six electrical components. The emitter is an LED supplied by a constant current limited by a series resistor. Phototransistors serve as detectors that supply a current through load resistors in proportion to the light illuminating them. The voltage across load resistors is output as Signal A (sine) and Signal B (cosine).

Other electronics may be added such as amplifiers, drivers, and direction sensing logic. Some applications may require voltage regulation, noise protection and reverse voltage protection. Interpolating the AC signal or embedding a microprocessor to digitize the signal can emulate the output of an incremental optical encoder.

Reference is now made to FIG. 4 in which there is illustrated a cross sectional view of the subject optical resolver 100. Housing 110 must be mounted to a secure and stationary surface and the rotating shaft 200 of the target apparatus as herein described. The optical and electrical elements must be assembled into a package that will function as a unit. Means for attaching rotating polarizer 120 to shaft 200 are present and may include, for example, hub 128. The rotating polarizer 120 is attached to cylindrical hub 128 which is adapted to slidably receive therein shaft 200. Emitter 118, stationary filter 122 and detector 124 are oriented along a common optical axis at some radius inside the circumference of rotating filter 120 and are held in place using appropriate mounting means. The electrical circuit must include wiring attached to each of the electronic elements and a connection to control circuits and power supply.

It is important to note that FIG. 4 illustrates only one example of how the optical components might be assembled. Many other configurations are possible. In this example, the rotating shaft 200 to be measured is inserted through an aperture 130 of base plate 132 and slidably received within hub 128 in the center of the device. Hub 128 is mounted to shaft 200 at a position that will maintain the non-contacting gap between the disk and any other stationary components. The rotating polarizer 120 is slidably received over shaft 200 and abuts flange 134. Retention collar 136 abuts the opposite side of rotating polarizer 120 and, together, flange 134 and retention collar 136 prevent axial displacement of the disk. Thusly mounted, rotating polarizer 120, hub 128 and retention collar 136 all rotate with shaft 200. Housing 110 holds the stationary elements in place. There are two printed circuit boards (“PCBs”) in this design. A first PCB 138 is mounted on the base to connect and position the surface mount LED. A second PCB 140 is suspended on the opposite side of the disk to position the stationary filters and connect the detectors and electrical components. Both PCBs are connected to conductive pins 142 that constitute the electrical connector. Means for adjusting electrical signal relative to shaft position and means for adjusting phase angle of electrical signals may also be employed. Finally, cover 144 is installed to protect the internal components from damage and contaminants.

In a more sophisticated construction, a means is provided for turning the stationary filters to reorient the polarization. Only 180 degrees of rotation is required. Knurled edges or simple slots in the filter that are exposed to the outside could be used to rotate the filter. This would allow precise adjustment of the resulting signals with respect to the shaft and with each other. This is very useful when aligning the signals for position and accuracy in some applications.

Referring now to FIG. 6, it may be observed that the output signal from an optical resolver is a natural sinewave (signal A). Another signal (signal B) 90 electrical (45 degrees mechanical) out of phase from the sine is a cosine. An Analog-to-Digital converter can be used to convert the optical resolver output signal DC levels to a digital number. Digital values for the sine and cosine can be used to calculate the angle of rotation. As illustrated, the arctangent of the A and B signals is a linear result with greater precision and resolution than the sine or cosine alone. The mechanical quadrant being measured can be determined through digital logic.

Several advantages of the subject invention exist over the prior art. Each are briefly set forth under separate heading below.

Concentricity of Rotating Member is not Critical

Because the rotating member of an optical resolver is a polarized plane having no relation to the axis of rotation. Since the polarized plane has no center there can be no concentricity error.

Non-Contacting Gap Between Members is not Critical

Within practical limits, signal quality of an optical resolver is not affected by the size of the non-contacting gap. The rotating member of the optical resolver need only polarize the illumination source to provide shaft angle information. The angle of polarization is independent of the distance between the polarization filter and the light source. Therefore the non-contacting gap can be large enough to account for any and all variations in environmental conditions or mechanical tolerances in every application.

Perpendicularity and Axial Runout of Rotating Member is not Critical.

Since the gap in an optical resolver is relatively large, there is virtually no danger of a collision between the rotating and stationary members. Variations in the width of the gap do not affect the polarization of the illumination and thus do not affect the accuracy of the device. Because the angle of polarization in the rotating and stationary filters is constant regardless of the parallelism of the two members, the accuracy of the device is not affected by perpendicularity or axial runout.

High Tolerance to Contamination

A much greater area of illumination is used in the optical resolver and small areas of contamination have much less effect on signal quality.

Signal Phase can be Adjusted Relative to Shaft Angle

To adjust an optical resolver, only the stationary polarizer needs to be rotated relative to the optical axis. This can be accomplished without risk and with greater precision.

Phase of Multiple Signals can be Adjusted Relative to Each Other

The phase relationship of the sine and cosine signals in an optical resolver is a function of the relative angle of polarization between the two stationary filters. Providing a means for rotating one of the filters relative to the other will enable adjustment of the signal phase. Thus phase errors can be virtually nullified.

Signal Type

The subject optical resolver provides an infinitely resolvable analog signal.

Low Power Requirements

The subject optical resolver can draw less than 10 mA at 5 volts or about 0.05 watts. This can be an important distinction for certain applications such as battery-powered operation, flammable environments, and systems requiring a large number of feedback devices.

Measures Absolute Angle of Rotation, Velocity and Direction of Rotation

The velocity of rotation (RPM) measured by an optical resolver is a function of the rate of change in signal level. The direction of rotation can be determined by the phase relationship between sine and cosine signals. In the “forward” direction, the sine leads the cosine by 90 electrical degrees. In reverse, the cosine leads the sine.

Simplicity of Construction

The filters of an optical resolver are readily obtained, are lightweight and may be assembled without great care. These materials and construction features make the optical resolver the lowest cost solution.

Although the present invention has been described with reference to the particular embodiments herein set forth, it is understood that the present disclosure has been made only by way of example and that numerous changes in details of construction may be resorted to without departing from the spirit and scope of the invention. Thus, the scope of the invention should not be limited by the foregoing specifications, but rather only by the scope of the claims appended hereto.

What is claimed as being new, useful and desired to be protected by Letters Patent of the United States is as follows:

1. A rotary motion detection device for measuring the angle of rotation of a rotating shaft, said device comprising:
a light emitter;
a polarizer having means for engaging a rotating shaft such that the rotating shaft causes said polarizer to rotate;
at least one stationary polarizer;
at least one photodetector;
said light emitter, said polarizer, said at least one stationary polarizer and said at least one photodetector being oriented along a common optical axis at some radius inside the circumference of said polarizer;
means for maintaining predetermined distances between and coplanar orientation among said light emitter, said polarizer, said at least one stationary polarizer and said at least one photodetector; and
electrical means for providing current to said light emitter and measuring electrical signals produced by said at least one photodetector.

2. A rotary motion detection device for measuring the angle of rotation of a rotating shaft, said device comprising:
a light emitter;
a light polarizer having means for engaging a rotating shaft such that the rotating shaft causes said polarizer to rotate;
a first stationary light polarizer having a first direction of polarization;
a first photodetector;
said light polarizer, said first stationary light polarizer and said first photodetector being oriented along a first common optical axis at some radius inside the circumference of said light polarizer;
means for maintaining predetermined distances between and coplanar orientation among said light emitter, said light polarizer, said first stationary light polarizer and said first photodetector;
a second stationary light polarizer having a second direction of polarization oriented at 45 degrees relative to said first direction of polarization of said first stationary light polarizer;
a second photodetector;
said light polarizer, said second stationary light polarizer and said second photodetector being oriented along a second common optical axis at some radius inside the circumference of said light polarizer;
means for maintaining predetermined distances between and coplanar orientation among said light emitter, said light polarizer, said second stationary light polarizer and said second photodetector;
said light emitter being capable of emitting light along said first common optical axis and said second common optical axis;
electrical means for providing current to said light emitter and measuring electrical signals produced by said first photodetector and said second photodetector.

3. A method of measuring angular rotation of a rotating shaft, the method comprising the steps of:
causing a shaft to be disposed though the center of a light polarizer;
aligning said light polarizer, a stationary light polarizer and a photodetector along a common optical axis at a radius inside the circumference of said light polarizer, said common optical axis being parallel with the axis of rotation of said shaft; causing the shaft and said light polarizer to rotate about said axis of rotation of said shaft;
emitting light through said rotating light polarizer, said stationary light polarizer and onto said photodetector;
measuring the current produced by the light emitted onto said photodetector as said shaft rotates; and
processing the measured data to determine the angle of rotation of the rotating shaft.
